(19) United States
(12) Patent Application Publication
(10) Pub. No.: US 2024/0390960 A1
(43) Pub. Date: Nov. 28, 2024

(54) PYROLYTIC REACTOR FOR RECOVERING CARBON FROM CERTAIN PLASTICS AND A SYSTEM AND METHOD FOR RECOVERING CARBON FROM CERTAIN PLASTICS

(71) Applicant: ANTARTICA LABS PTE LTD, Singapore (SG)

(72) Inventors: Dawen CHOY, Singapore (SG); LiLi ZHANG, Singapore (SG)

(73) Assignee: ANTARTICA LABS PTE LTD, Singapore (SG)

(21) Appl. No.: 18/267,967

(22) PCT Filed: Feb. 18, 2022
(86) PCT No.: PCT/SG2022/050079

§ 371 Date: Jun. 16, 2023

(51) Int. Cl. B09B 3/70; B09B 3/35; B09B 3/40; B09B 101/75; C01B 3/00; C01B 32/05; C10B 53/07; C10B 57/06; H01M 8/0612

(52) U.S. Cl. CPC B09B 3/70; B09B 3/35; B09B 3/40; C01B 3/001; C01B 32/05; C10B 53/07; C10B 57/06; H01M 8/0643; B09B 2101/75

(57) ABSTRACT

A pyrolytic reactor (10, 200, 300) for recovering carbon from certain plastics comprising: at least one reactor vessel (12), the at least one reactor vessel (12) having a first reaction chamber (34) and a second reaction chamber (42); a material delivery system (32) for delivering the certain plastics in particulate form to the first reaction chamber (34); a catalyst delivery system (46) for delivering a metal catalyst to the second reaction chamber (42); and a separator (20). The particulate plastic material is heated in the first reaction chamber (34) to a first temperature range so as to decompose into a collection of gases that are heated in the second reaction chamber (42) in conjunction with the metal catalyst to form a collection of post-reactor gases (comprised principally of hydrogen gas) having carbon coated catalytic material entrained therein, the separator (20) operable to separate at least some of the carbon coated catalytic material from the post-reactor gases.

### FIELD OF THE INVENTION

The invention relates to a pyrolytic reactor for recovering carbon from certain plastics and an associated system and method for recovering carbon from certain plastics. In its preferred form, the pyrolytic reactor has been designed to recover carbon in a domestic or light commercial setting from waste plastics.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

The chemical process of pyrolysis has previously been used to recycle certain plastics with an aim of recovering the oils contained therein. In this context, the process is an industrial one rather than a domestic or light commercial one.

The difference here is marked. For example, a by-product that produces a noxious, but not toxic, smell may be dealt with by providing masks to operators of an industrial plant. This same approach, however, is not a real solution for dealing with the by-product in a domestic or light commercial setting. Other by-products of the recycling process might produce differing effects that also must be deal with differently between industrial, domestic and light commercial settings (for instance, noise pollution, or potential for damage to occupant health).

A further problem specific to the intent of the invention is that the plastics that can be recycled using current pyrolytic methods are hydrocarbon-based. This means that any attempt to recover carbon from such plastics introduces a further problem of how to deal with the safety concerns that accompany the resulting hydrogen gas, especially in a domestic or light commercial setting.

It is therefore an object of the present invention to provide a pyrolytic reactor for recovering carbon from certain plastics. It is a secondary, optional, object of the present invention to provide such a reactor that can be used in a domestic or light commercial setting.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is a pyrolytic reactor for recovering carbon from certain plastics comprising:
at least one reactor vessel, the at least one reactor vessel having a first reaction chamber and a second reaction chamber;
a material delivery system for delivering the certain plastics in particulate form to the first reaction chamber;
a catalyst delivery system for delivering a metal catalyst to the second reaction chamber; and
a separator,
where the particulate plastic material is heated in the first chamber to a first temperature range so as to decompose into a collection of gases that are heated in the second reaction chamber in conjunction with the metal catalyst to form a collection of post-reactor gases having carbon-coated catalytic material entrained therein, the separator operable to separate at least some of the carbon coated catalytic material from the post-reactor gases.

Preferably, the first temperature range is between 450° C. and 600° C., while the second temperature range is between 700° C. and 800° C.

The separator may be a cyclonic separator.

In a preferred arrangement, the metal catalyst is an iron-based catalyst.

Each reaction chamber of the first reactor vessel may be heated by an electric furnace. In one configuration, the electric furnace is a multi-zone electric furnace, at least one zone of the multi-zone electric furnace operable to heat the first reaction chamber and at least one zone of the multi-zone electric furnace operable to heat the second reaction chamber.

The second reaction chamber may be positioned above the first reaction chamber with a connecting chamber operable to connect the first reaction chamber to the second reaction chamber.

The second reaction chamber may also include a perforated base plate, the perforations of the base plate being sized so as to allow gases to pass therethrough but prevent the metal catalyst from falling therethrough.

The pyrolytic reactor may also comprise a channel mixer, the channel mixer operable to deliver at least one of the following: post-reactor gases to the first reactor chamber; post-reactor gases to the second reactor chamber; nitrogen to the second reactor chamber; hydrogen to the second reactor chamber; nitrogen to the first reactor chamber; hydrogen to the first reactor chamber.

The material delivery system may operate to unseal an opening in a sealed removable cartridge to allow the particulate plastic material contained therein to pass to a first feeder unit that delivers the particulate plastic material to the first reaction chamber. The first feeder unit may take the form of an Archimedes screw that delivers the particulate plastic material to the bottom of the first reaction chamber. Ideally, the material delivery system has a feed rate of between 0.5 and 10 grams per minute.

The catalyst delivery system may comprise a catalyst hopper that feeds the metal catalyst to a second feeder unit that delivers the metal catalyst to the second reaction chamber. The second feeder unit may also take the form of an Archimedes screw that delivers the metal catalyst to the top of the second reaction chamber. As with the material delivery system, the catalyst delivery system ideally has a feed rate of between 0.5 and 10 grams per minute.

In a preferable configuration, the ratio of catalyst to particulate material is one of the following: 1:2; 1:4; 1:6.

The pyrolytic reactor may further include a cooling system for cooling a portion of the first feeder unit proximate the first reaction chamber. The cooling system may take the form of a pipe for recirculating a thermal fluid.

In one form of the invention, the post-reactor gases separated by the separator are oxidised in a combustion chamber. The combustion chamber may be configured to deliver at least some by-products of the oxidisation process back to the first reaction chamber (the intended by-products being CO₂ and N₂). In yet a further arrangement, the combustion chamber is controlled by a control system, the control system operable to initiate the oxidisation process only on determination of a variable exceeding a predetermined threshold level. This variable may be any of the following: the pressure level within the combustion chamber; the number of times the post-reactor gases have passed through the combustion chamber; expiry of time.

The pyrolytic reactor may include an energy recovery system to recover at least some of the chemical energy generated in the combustion chamber. The energy recovery system may be used to provide power to an electric furnace used to heat either the first reaction chamber, the second reaction chamber, or both the first and second reaction chambers.

In an alternative variation, the post-reactor gases separated by the separator are delivered to a solid-oxide fuel cell.

In a third alternative variation, the post-reactor gases separated by the separator are delivered to a hydrogen recovery system. Preferable, the hydrogen recovery system comprises a removable cartridge filled with metal compounds through which the post-reactor gases are directed, the metal compounds capable of absorbing hydrogen to form hydrides.

In accordance with a second aspect of the present invention, there is a device for creating particulate material from certain plastics comprising:
a receptacle into which a plastic article may be deposited;
a grinder for grinding the deposited plastic article into particulate material; and
a removable cartridge for receiving the particulate material from the grinder,
where, the removable cartridge, when removed from the device, is sealed so as to prevent the particulate material from entering the environment as it is transferred from the device to form part of the material delivery system of a pyrolytic reactor according to claim 1.

The removable cartridge may have an open face, the device operable to seal the removable cartridge by applying a protective membrane over the open face prior to removal.

The receptacle may incorporate an automatic identification system, the receptacle operable to allow the deposit of a plastic article on recognition of the article as recoverable by the automatic identification system.

In accordance with a third aspect of the present invention there is a system for recovering carbon from certain plastics, the system comprising:
a pyrolytic reactor according to the first aspect of the present invention;
a device for creating particulate material according to the second aspect of the present invention,
where the material delivery system operates to unseal an opening in the sealed removable cartridge retrieved from the device to allow the particulate plastic material contained therein to pass to a first feeder unit that delivers the particulate plastic material to the first reaction chamber.

In accordance with a fourth aspect of the present invention there is a method for recovering carbon from certain plastics, the method comprising the steps of:
heating particulate material in a first reaction chamber of at least one reactor vessel to a first temperature range so as to decompose the particulate material into a collection of gases;
delivering a metal catalyst to a second reaction chamber of at least one reactor vessel;
heating the collection of gases and the metal catalyst in the second reaction chamber to a second temperature range to form a collection of post-reactor gases having a carbon-coated catalytic material entrained therein;
separating the carbon-coated catalytic material from the post-reactor gases.

Preferably, the first temperature range is between 450° C. and 600° C., while the second temperature range is between 700° C. and 800° C.

In a preferred form, the step of separating the carbon-coated catalytic material from the post-reactor gases is achieved by centrifugal separation.

Ideally, the catalyst is an iron-based catalyst.

The method may also include the step of using the collection of gases to agitate the catalyst in the second reaction chamber.

The method may also include the step of using a channel mixer to deliver at least one of the following: post-reactor gases to the first reactor chamber; post-reactor gases to the second reactor chamber; nitrogen to the second reactor chamber; hydrogen to the second reactor chamber; nitrogen to the first reactor chamber; hydrogen to the first reactor chamber.

The method may also include the steps of:
unsealing an opening in a sealed removable cartridge to allow the particulate plastic material contained therein to pass to a first feeder unit; and
using the first feeder unit to deliver the particulate plastic material to the first reaction chamber.

The first feeder unit preferably delivers particulate material to the first reaction chamber at a feed rate of between 0.5 and 10 grams per minute. Similarly, it is preferred that the step of feeding the metal catalyst to the top of the second reaction chamber has a feed rate of between 0.5 and 10 grams per minute. The ratio of the feed rate of the catalyst to the feed rate of the particulate material is preferably one of the following: 1:2; 1:4; 1:6.

The method may also include the step of cooling a portion of the first feeder unit proximate the first reaction chamber.

In a first alternative configuration, the method further includes the step of oxidising the post-reactor gases in a combustion chamber. In this configuration, the method may also include the step of delivering at least some by-products of the oxidisation process back to the first reaction chamber (the by-products preferably being CO₂ and N₂). The step of oxidising the post-reactor gases in the combustion chamber may only be initiated when a control system determines that a variable exceeds a predetermined threshold level, the variable being one of the following: the pressure level within the combustion chamber; the number of times the post-reactor gases have passed through the combustion chamber; expiry of time.

The method may also include the steps of:
recovering at least some chemical energy generated in the combustion chamber; and
using the recovered energy to power an electric furnace used to heat either the first reaction chamber, the second reaction chamber, or both the first and second reaction chambers.

In a second alternative configuration, the method may further comprise the step of delivering the post-reactor gases to a solid-oxide fuel cell.

In a third alternative configuration, the method may further comprise the step of delivering the post-reactor gases to a hydrogen recovery system. The hydrogen recovery system may comprise a removable cartridge filled with metal compounds through which the post-reactor gases are directed, the metal compounds capable of absorbing hydrogen to form hydrides.

The method may also include the steps of:
grinding a deposited plastic article into particulate material;
depositing the particulate material into a removable cartridge; and
sealing the removable cartridge so as to prevent the particulate material from entering the environment during transfer.

The method may further include the steps of:
identifying a plastic article; and
allowing the plastic article to be deposited for grinding only if the plastic article is recognised as being made from, or predominantly from, one of the certain plastics.

### BRIEF DESCRIPTION OF THE DRAWINGS

The invention will now be described, by way of example only, with reference to the accompanying drawings, in which:

FIG. 1 is a schematic of a pyrolytic reactor for recovering carbon from certain plastics in accordance with a first embodiment of the invention.

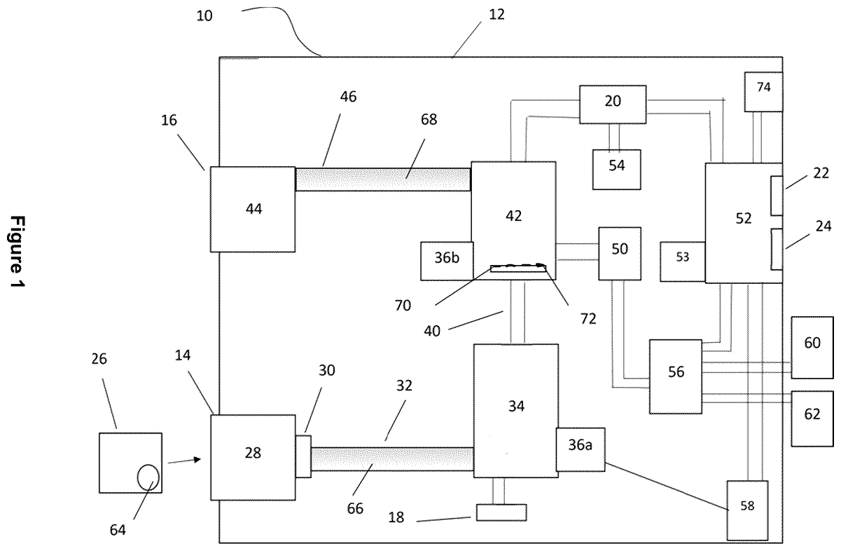

FIG. 2 is a schematic of a pyrolytic reactor for recovering carbon from certain plastics in accordance with a second embodiment of the invention.

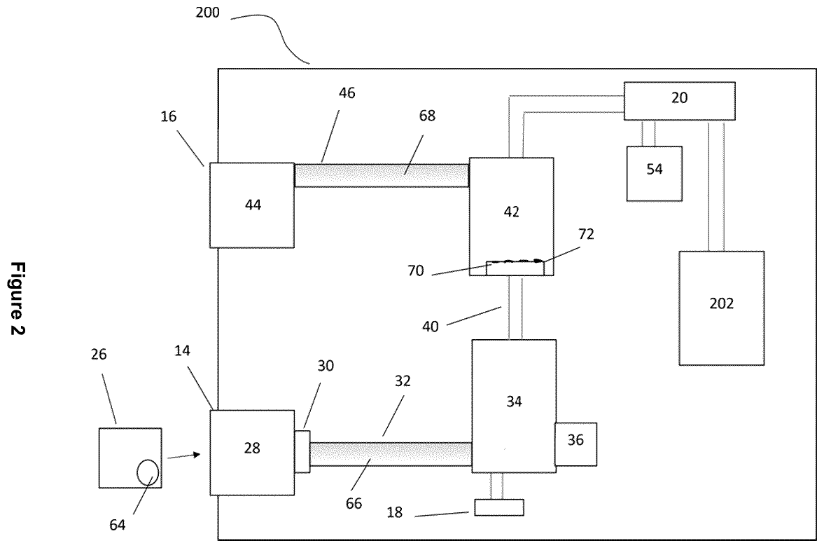

FIG. 3 is a schematic of a pyrolytic reactor for recovering carbon from certain plastics in accordance with a third embodiment of the invention.

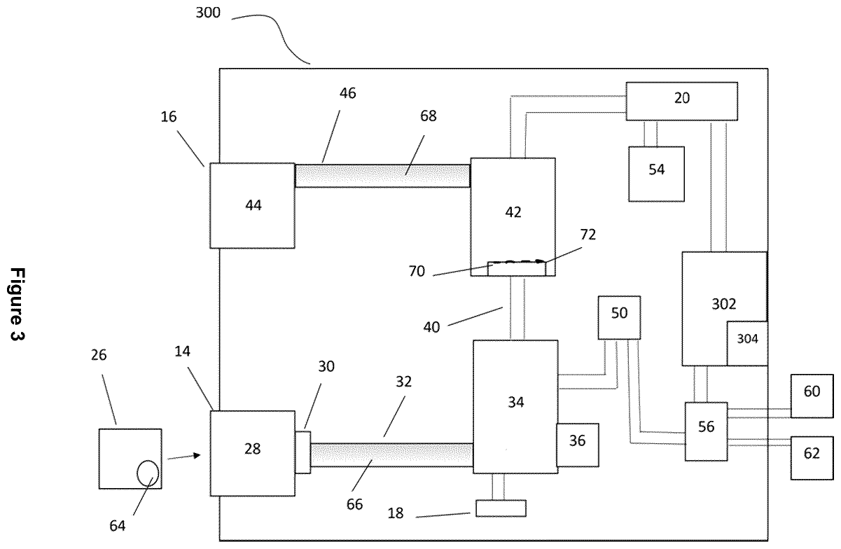

FIG. 4 is a flowchart of a method of recovering carbon from certain plastics in line with any of the first to third embodiments of the invention.

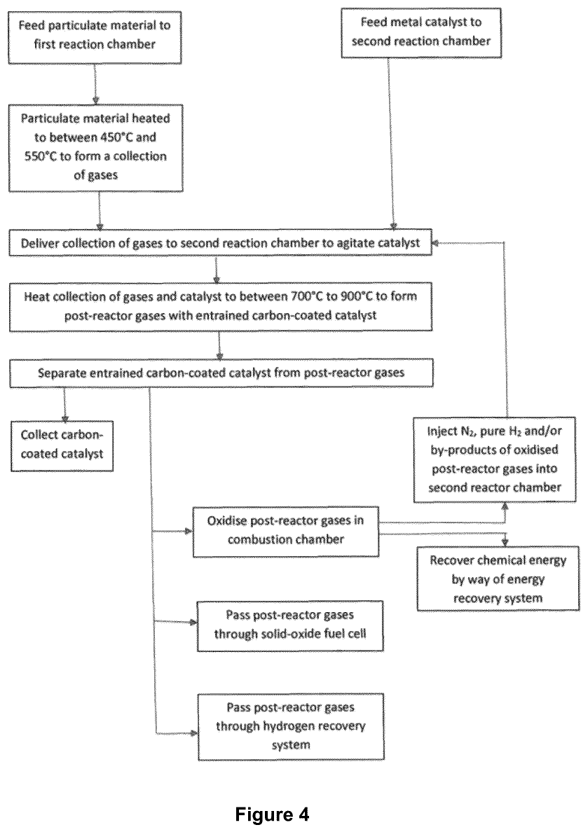

FIG. 5 is a schematic view of a first bin as used with any of the first to third embodiments of the invention.

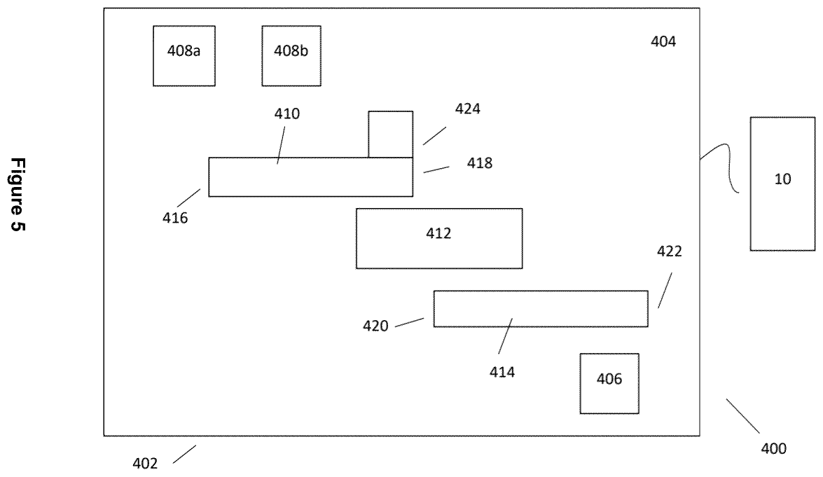

FIG. 6 is a plan view of a grinder unit as used in the first bin as shown in FIG. 5.

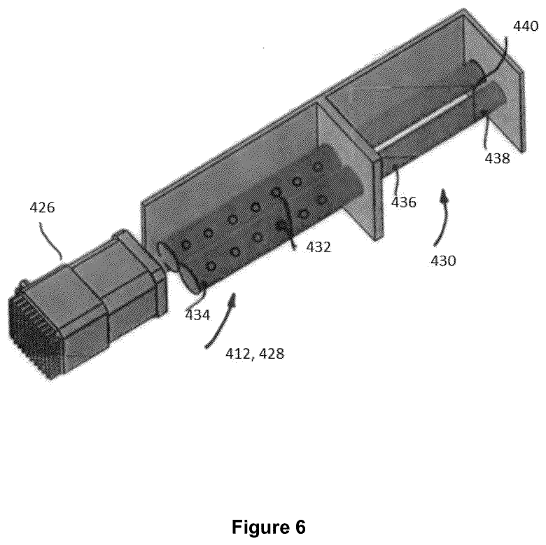

FIG. 7 is a schematic view of a second bin as used with any of the first to third embodiments of the invention.

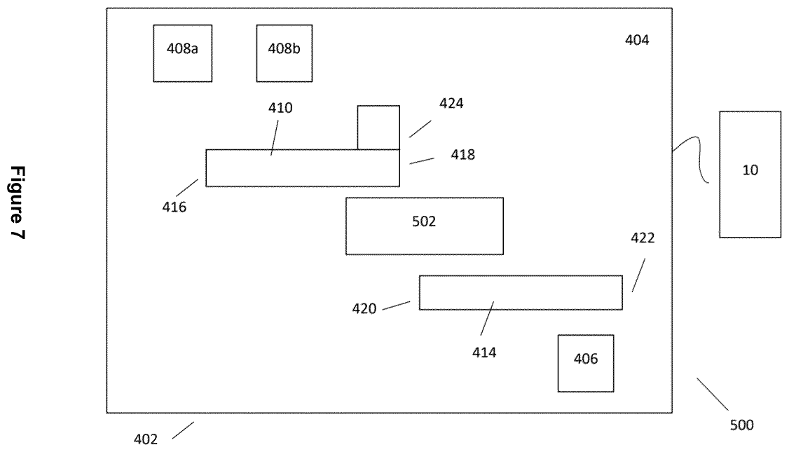

FIG. 8 is a plan view of a grinder unit as used in the second bin as shown in FIG. 6.

### PREFERRED EMBODIMENTS OF THE INVENTION

In accordance with a first embodiment of the invention there is a reactor unit 10. The reactor unit 10 has a hollow housing 12. The hollow housing 12 is ideally stylised in accordance with is intended surrounds, such as the lobby of an apartment building.

Provided in the housing 12 is a chute hatch 14, a catalyst door 16, a waste outlet 18, a cyclonic separator 20, an air vent 22 and a fluid valve 24.

The chute hatch 14 is of size and dimensions so as to receive a removable cartridge 26. The chute hatch 14 opens up to a cartridge chamber 28. The cartridge chamber 28 has an opening 30 leading to a first feeder unit 32.

The first feeder unit 32 of this embodiment takes the form of an Archimedes screw. The first feeder unit 32 operates to convey material received by way of the opening 30 to a first reactor chamber 34.

The first reactor chamber 34 is heated by electric furnace 36a. The first reactor chamber 34 is connected to a second reactor chamber 42 by way of a connecting conduit 40. The second reactor chamber 42 is positioned above the first reactor chamber 34 within the housing 12 when operational.

The first reactor chamber 34 is also connected to the waste outlet 18.

The catalyst door 16 opens up onto a catalyst hopper 44. The catalyst hopper 44 leads to a second feeder unit 46. The second feeder unit 46 of this embodiment also takes the form of an Archimedes screw. The second feeder unit 46 operates to convey a catalyst to the second reactor chamber 42.

The second reactor chamber 42 is in fluid communication with the cyclonic separator 20 and a gas injector 50. The second reactor chamber 42 is heated by electric furnace 36b.

The cyclonic separator 20 is in fluid communication with a combustion chamber 52. The cyclonic separator 20 leads to a recovery chamber 54. The gas injector 50 is in fluid communication with a channel mixer 56.

The combustion chamber 52 incorporates the intake air vent 22 and the exhaust valve 24. The combustion chamber 52 is controlled by a control unit 53.

The combustion chamber 52 is also in fluid communication with an energy recovery system 58 and the channel mixer 56. The energy recovery system 58 is in electrical communication with the electric furnace 36.

The channel mixer 56 in this embodiment is a three-channel channel mixer 56. The channel mixer 56 is in fluid communication with a pure nitrogen source 60 and a pure hydrogen source 62.

This embodiment of the invention will now be described in the context of its intended use.

Preferably, when the removable cartridge 26 contains between 500 g and 1,000 g of plastic in particulate form (hereafter “the particulate material”), the user conveys the removable cartridge 26 to the reactor unit 10. The reactor unit 10 is located in a central domestic location, such as the lobby of an apartment building. In this manner, the reactor unit 10 is meant to adopt an easily accessed, but visually unobtrusive presence, similar to general vending machines.

It should also be noted here that the removable cartridge 26 has an opening 64 through which the particulate material is able to exit the removable cartridge 26. At the same time, the removable cartridge 26 is a sealed unit prior to installation in the reactor unit 10 so as to prevent microplastics from entering the environment.

The removable cartridge 26 is then installed in the cartridge chamber 28 by way of the chute hatch 14. Installation of the removable cartridge 26 within the cartridge chamber 28 aligns the opening 64 in the removable cartridge 26 with opening 30. This allows the particulate material to be emptied out of the removable cartridge 26 through the opening 64 to the first feeder unit 32.

The particulate material is captured by spiral segments 66 for conveyance to the first reactor chamber 34. In this manner, the particulate material is fed to the bottom of the first reactor chamber 34 at a feed rate of between 0.5 and 10 grams per minute.

Electric furnace 36a operates to continuously heat the internal area of the first reactor chamber 34 to a temperature of between 450° C. and 600° C. Heating the particulate material to this temperature results in decomposition to a collection of gases, although some particulate material may still remain. This process also maintains the overall temperature of the collection of gases within this 450° C. and 600° C. temperature range. This is important to prevent condensation of the gases.

The vapourised gases rise to the top of the first reactor chamber 34 where they are directed by the connecting conduit 40 to the second reactor chamber 42. The remaining particulate material is directed to waste outlet 18.

The catalyst hopper 44 in this embodiment is loaded with an iron-based catalyst. The catalyst hopper 44 feeds the catalyst into spiral segments 68 for conveyance to the second reactor chamber 42. In this manner, the catalyst is fed to the top of the second reactor chamber 42 at a feed rate of between 0.5 and 10 grams per minute.

The fed catalyst forms a fluidised bed on a base plate 70 located in the bottom of the second reactor chamber 42. The base plate 70 has a plurality of apertures 72 provided therein to allow the collection of gases to pass therethrough, but are of insufficient size to allow the catalyst to pass therethrough back towards the first reactor chamber 34. At the same time, as the collection of gases pass through such apertures 72, they agitate the catalyst in the fluidised bed to facilitate greater reaction between the catalyst and the collection of gases.

The second reactor chamber 42 is heated by electric furnace 36b, raising the temperature within the second reactor chamber 42 to between 700° C. to 800° C. At this temperature, the catalyst reacts with the collection of gases to break down the CH bonds. This also causes the carbon molecules to form about the catalyst, thereby in effect coating it. The catalytic reaction also results in the production of primarily H₂ and a minority percentage of CₓH_{y} (where x and y are values representative of any chemical combination of C and H), along with trace amounts of CO and CO₂. These gases are referred to hereafter as the “post-reactor gases”.

The post-reactor gases, with the coated catalyst entrained therein, are then conveyed to the cyclonic separator 20.

The cyclonic separator 20 operates to separate the coated catalyst form the post-reactor gases using centrifugal force in a manner as would be readily known to the person skilled in the art. This separation results in the coated catalyst being directed to the recovery outlet 54, while the post-reactor gases are directed to the combustion chamber 52.

The coated catalyst, as delivered to the recovery chamber 54, is then able to be recovered for subsequent treatment to separate the catalyst from the carbon.

The post-reactor gases are conveyed from the cyclonic separator 20 to the combustion chamber 52. The pressure level of the combustion chamber 52 is being continuously monitored by the control unit 53. If the pressure level is below a predetermined threshold value, the post-reactor gases pass through the combustion chamber 52 to be re-injected into the second reactor chamber 42 via the channel mixer 56 and the gas injector 50.

It is to be noted here that the gas injector 50 supplies the first reactor chamber 34 with gases from the channel mixer 56. As described above, the channel mixer 56 mixes gases from three channels, namely, recirculated post-reactor gases (as described in more detail below), nitrogen from the nitrogen source 60 and pure hydrogen from the hydrogen source 62.

The injection of pure hydrogen to the second reactor chamber 42 assists the catalytic reaction on start-up of the pyrolytic reactor 10 and thus is only introduced during the start-up phase of the reactor. Specifically, it assists in converting the catalyst into a more active iron form rather than its typical iron-oxide form.

Similarly, the injection of nitrogen to the second reactor chamber 42 assists with the general flow of the collection of gases/post-reactor gases. This includes the agitation of the catalyst forming about the fluidised bed and allowing the coated catalyst to float about the second reactor chamber 42.

Each recirculation of the post-reactor gases through the second reactor chamber 42 and cyclonic separator 20 increases the percentage conversion of the residual CₓH_{y} gases to hydrogen gas, which also results in an increase in pressure. Furthermore, by recirculating the post-reactor gases while the pressure level remains below the predetermined threshold (representing a “safe” pressure level), the invention seeks to extract the highest level of carbon and hydrogen gas from the particulate material.

However, if the control unit 53 assesses the pressure level of the combustion chamber 52 as being above the predetermined threshold value, the control unit 53 turns on a live flame, which oxidises the post-reactor gases. Oxidisation results in the post-reactor gases combining to form water and CO₂. To ensure that the live flame remains present, and to produce these chemical reactions, compressed air is delivered into the combustion chamber 52 by way of intake air vent 22.

Oxidisation of the post-reactor gases is important for two reasons:
it prevents an unsafe build-up of hydrogen gas in the combustion chamber 52; and
it converts potential environmental pollutants (such as carbon monoxide) into more suitable gases for discharge (such as carbon dioxide).

Due to the heat of the oxidisation, the limited quantity of water produced by the chemical reactions in the combustion chamber 52 will be in vapour form and is removed therefrom by way of the exhaust valve 24. Any CO₂ by-product and un-combusted N₂ is also ejected via exhaust valve 24.

The oxidisation process also has an additional benefit in that the energy recovery system 58 operates to recover some of the chemical energy released by combustion within the combustion chamber 52. The energy recovered by the energy recovery system 58 is used to feed electric furnaces 36a, 36b. In this manner, the overall energy needs of the system are reduced.

In accordance with a second embodiment of the invention, where like numerals reference like parts, there is a pyrolytic reactor 200. The pyrolytic reactor 200 is identical to the pyrolytic reactor 10 except that the combustion chamber 52 is replaced with a fuel cell 202 and the first feeder unit 32 is further modified.

The fuel cell 202 in this embodiment is a solid-oxide fuel cell. The post-reactor gases delivered to the fuel cell 202 are processed to produce water and CO₂ gas. The CO₂ gas is first vented by the fuel cell 202 to the atmosphere in general, while the water is recycled within the fuel cell 202 to react with the incoming hydrocarbons contained in the post-reactor gases.

The chemical processes that occur within the fuel cell 202 operate to generate power which is stored therein. This power stored by the fuel cell 202 can be used to power the electric furnaces 36 or be fed back into the main electricity grid (or both).

The first feeder unit 32 incorporates a fluid pipe (not shown). The fluid pipe constantly recirculates a thermal fluid about the first feeder unit 32 about the opening 30. The recirculation of the thermal fluid operates to cool the lip (not shown) of the first feeder unit 32 proximate the first reactor chamber 34. This in turn prevents the particulate material from melting prior to entry into the first reactor chamber 34 and, potentially, clogging the first feeder unit.

In accordance with a third embodiment of the invention, where like numerals reference like parts, there is a pyrolytic reactor 300. The pyrolytic reactor 300 is identical to the pyrolytic reactor 10 except that the combustion chamber 52 is replaced with a hydrogen recovery system 302.

In this embodiment, the hydrogen recovery system 302 takes the form of a removable cartridge 304. The removable cartridge 304 is pressurised to between two (2) to three (3) atmospheres.

The removable cartridge 304 is filled with metal compounds that are capable of absorbing hydrogen and thereby produce hydrides. Such metal compounds are well known to the hydrogen generation industry and thus will not be discussed in more detail here.

During operation, the post-reactor gases are directed through the removable cartridge 304. These gases react with the metal compounds to form the aforementioned hydrides. The remaining hydrocarbons and small amounts of CO/CO₂ are then recirculated via gas mixer 56 and gas injector 50 back into the first reactor chamber 34 for further processing until all hydrogen has been extracted from the system after a pre-defined period of time. The remaining gases, which will only contain trace CO/CO₂, can then be safely vented into the general environment.

In accordance with a fourth embodiment of the invention there is a pyrolytic system 400 for processing plastics. The pyrolytic system 400 comprises a bin 402 and a pyrolytic reactor 10,200,300 according to any of the previous embodiments.

The bin 402 has a stylish housing 404. The housing 404 has a removable cartridge 406 and a pair of chute hatch 408a, 408b. The external profiles of both the removable cartridge 406 and the chute hatches 408a, 408b are styled to seamlessly match the external profile of the remainder of the housing 404.

The stylish housing 404 houses an upper conduit 410, a grinder 412 and a lower conduit 414.

The upper conduit 410 has a chute end 416 and a grinder end 418. The lower conduit 414 similarly has a grinder end 420 and a cartridge end 422.

In this embodiment, the upper conduit 410 incorporates a material sorter 424 for separating cans and cartons from other recyclable material. Any form of material sorter may be used as would be well known to those involved in the design of such systems. However, as the material sorter is not crucial to the present invention, it will not be described in more detail here.

The grinder 412 has a motor 426, a shredder unit 428 and a crusher unit 430. A drive shaft (not shown) attached to the motor 426 operates to drive both the shredder unit 428 and the crusher unit 430. The motor 426 draws mains power to operate.

The shredder unit 428 comprises a first pair of rollers 432 arranged in parallel. Each roller 432 has teeth extending therefrom in a set pattern across its whole external surface 434. The rollers 432 are spaced from each other at a distance slightly greater than the height of the teeth.

The crusher unit 430 comprises a second pair of rollers 436 arranged in parallel. Each roller 436 has a smooth external surface 438. The rollers 436 are spaced from each other such that a gap 440 is formed therebetween, based on the desired final thickness of the crushed products.

This embodiment of the invention will now be described in the context of its intended use.

The user sets up the bin 402 in its intended location in their home. The bin 402 is then connected to mains power, so as to provide electrical power to the various components of the bin 402 and, in particular, the motor 426.

When the user has some suitable material for recycling, such as specified plastics, aluminium cans, or cardboard cartons, the user opens the chute hatch 408a and places the material therein. The deposited material is received by the upper conduit 410 at the chute end 416.

The deposited material travels along the upper conduit 410 from the chute end 416 to the grinder end 418. As it travels along the upper conduit 410 the material sorter 424 assesses the deposited material to determine its nature. Following assessment, the material sorter 424 operates to direct the deposited material towards the section of the grinder end 418 aligned with either the shredder unit 428 or the crusher unit 430, as appropriate.

If the deposited material is directed towards the shredder unit 428, the material drops off the grinder end 418 onto the shredder unit 428. If not deposited into the space between the first pair of rollers 432, the teeth provided about the face of the rollers 432 operate to grab the deposited material and drag it towards this space. At the same time, the deposited material that has reached the space between the first pair of rollers 432 is ground up by the teeth as the rollers 432 rotate to form particulate material. The particulate material falls onto the lower conduit 414 at the grinder end 420.

The particulate material travels along the lower conduit 414 from the grinder end 420 to the cartridge end 422. When the material reaches the cartridge end 422 it is deposited into the removable cartridge 406 inserted into cartridge receptacle (not shown) where it is sealed for transfer to the pyrolytic reactor 10, 200, 300.

If the deposited material is directed to the crusher unit 430, the material drops off the grinder end 418 onto the crusher unit 428. More specifically, the longer axis of the deposited material is arranged to be in parallel with the rotational axis of each roller 436 and be received therebetween. In this manner, rotation of each roller 436 operates to draw the deposited material into the space therebetween where it is crushed. The crushed deposited material then falls directly to chute hatch 408b where it can be accessed by a user for recycling or disposal through other channels.

In accordance with a fifth embodiment of the invention, where like numerals reference like parts, there is a pyrolytic system 500 for processing plastics. This second embodiment of the invention only differs from the fourth embodiment in the composition of the bin 402

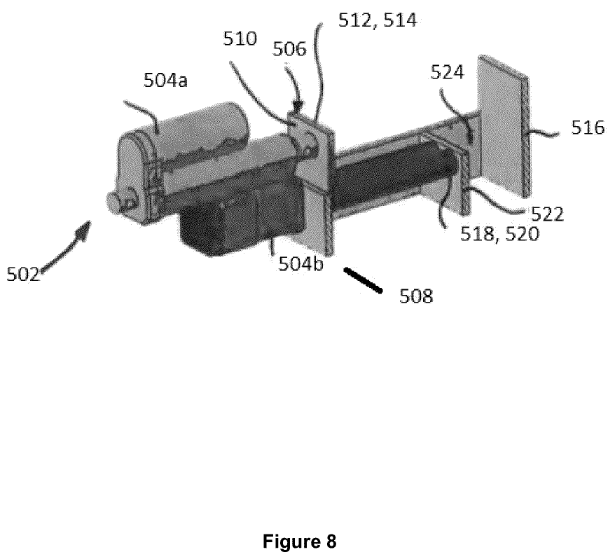

More specifically, in this embodiment, the grinder 420 is replaced with grinder 502. This grinder 502 comprises a plurality of motors 504, a crusher unit 506 and a shredder unit 508. The crusher unit 506 is positioned above the shredder unit 508 as shown in FIG. 8.

The crusher unit 506 incorporates a piston 510 mechanically connected to, and controlled by, a first motor 504a. The piston 510 has a crushing panel 512 attached to its moveable end 514. The crusher unit 506 further incorporates a first fixed wall 516. The horizontal axis of the piston 510 aligns with the central vertical axis of the first fixed wall 516.

The shredder unit 508 comprises a first pair of rollers 518 arranged in parallel. Each roller 518 has studs extending therefrom in a set pattern across its whole external surface 520. The rollers 518 are spaced from each other at a distance slightly greater than the height of the studs.

The rollers 518 are mechanically connected to, and controlled by, a second motor 504b. Furthermore, the rollers 518 are connected to a second fixed wall 522 at their end not mechanically connected to the second motor 504b. This also creates a gap 524 between the first fixed wall 516 and the second fixed wall 522.

This embodiment of the invention will now be described.

The deposited material is placed in the bin 402 and makes its way to grinder 502 in the same manner as described in the first embodiment, however, in this case the deposited material is simply directed to the grinder end 418 in this embodiment (there not being separate sections of the grinder end 418 for the material sorter 414 to direct the deposited material too).

Rather, in this case the deposited material drops off the grinder end 418 straight onto the rollers 432.

If the material sorter 424 identifies the material as being directed to the crusher unit 506, the longer axis of the deposited material is arranged to be in parallel with the rotational axis of each roller 518 and be received therebetween. Once the deposited material is so positioned, the piston 510 is activated, causing the crushing panel 512 to move towards the first fixed wall 516. This causes the deposited material to make contact with the crushing panel 512 first, which pushes it towards the first fixed wall 516. Ultimately, the extension of the piston 510 causes the deposited material to be crushed between the crushing panel 512 and the first fixed wall 516.

The piston 510 then retracts to its original position clear of the rollers 518. This leaves the crushed deposited material to fall down the gap 524 to chute hatch 408b.

If the material sorter 424 identifies the material as being directed to the shredder unit 508, the deposited material is directed to fall onto the rollers 518. The rollers 508 rotate about their respective longitudinal axis by way of second motor 504b.

If the material is not deposited into the space between the rollers 518, the studs provided about the face of the rollers 518 operate to grab the deposited material and drag it towards this space as they rotate. At the same time, the deposited material that has reached the space between the rollers 518 is ground up by the studs as the rollers 518 to form particulate material. The particulate material falls onto the lower conduit 414 where it again is processed in the same manner as described in the fourth embodiment.

While the purpose of the invention is to facilitate the processing of certain plastics within a domestic or light commercial setting in which more stringent environmental controls are imposed, there is no reason why the invention cannot be used in an industrial environment. In fact, due to the greater environmental benefits of the invention, if the present invention is commercially feasible, its use as an industrial process is encouraged.

It should be further appreciated by the person skilled in the art that the above invention is not limited to the embodiments described. In particular, the following modifications and improvements may be made without departing from the scope of the present invention:
The housing 12 may incorporate multiple cartridge chambers 28. The multiple cartridge chambers 28 may be configured to deliver particulate material from removable cartridges 26 to a single, central first feeder unit 32.
In a further variation, each cartridge chamber 28 may be associated with a first feeder unit 32, such that particulate material from a removable cartridge 26 is conveyed by way of its associated first feeder unit 32 to the first reactor chamber 34.
The removable cartridge 26 may incorporate a radio frequency identification tag, the chute hatch 14 biased to a locked position until such time as a removable cartridge having a recognised radio frequency identification tag is in communication range with the reactor unit 10, 200, 300. In this manner, the reactor unit 10,200,300 can be protected from parties seeking to clog the chute hatch 14 or having deposited unrecyclable objects therein.
In a yet further alternative configuration, the chute hatch 14 may be biased to the locked position until such time as a set of mechanical and/or electronic actuators are actuated by physical aspects of the removable cartridge 26.
The removable cartridge 26 may be an open-faced cartridge prior to removal from the bin 402. When intended to be removed from the bin 402, the bin 402 may operate to apply a protective membrane over the open face of the cartridge so as to prevent loss of the particulate material and/or crushed deposited material during transport to the reactor unit 10,200,300, but still being able to be pierced when received by the reactor unit 10, 200, 300.
It is desirable that the connecting conduit 40 be as short as possible so as to minimise temperature losses in the vapourised gases, which can result in condensation of the oils contained therein.
The actual feed rates of the particulate material and/or catalyst may be modified by the user at the time of processing or may be determined by automatic assessment of the type of material contained in the removable cartridge 26.
The feed rate of the particulate material may differ from the feed rate of the catalyst. Specifically, the applicant believes there are advantages to a catalyst to particulate material feed rate of 1:2; 1:4 and 1:6.
Any of the first three embodiments may be modified to introduce a hopper between the opening 30 and the first feeder unit 32. In this manner, even finer control of the feed rate of the particulate material can be achieved. In variations where multiple cartridge chambers 28 are employed, the hopper may be centralised to receive particulate material from the removable cartridges 26 received in each cartridge chamber 28.
The first reactor chamber 34 and second reactor chamber 42 may be formed by partitioning a single reactor vessel. In such a configuration, rather than having separate electric furnaces 36 heating each chamber individually, the vessel may be heated by a multi-zone electric furnace. The multi-zone nature of the electric furnace allowing for the different temperature ranges required of the reaction chambers 34, 42.
The catalyst used in the above embodiments may be a metal catalyst that is not iron based.
The cyclonic separator 20 may be replaced with other systems that can separate the entrained carbon coated catalyst from the post-reactor gases.
The control unit 53 may operate to initiate oxidisation of the combustion chamber 52 based on factors other than pressure. For instance, the control unit 53 may operate to initiate oxidisation based on elapsed time or the amount of times that the post-reactor gases have been recirculated.
The pyrolytic reactor 10,200,300 may operate on a continuous or batch basis. Ideally, the pyrolytic reactor 10,200,300 is adapted to monitor the stock of catalyst and particulate material and only initiates operation when the stock of each is at acceptable levels.
In an alternative configuration, the gas injector 50 may be arranged to deliver the gases that flow through the channel mixer 56 to the upper area of the first reactor chamber 34 rather than to the second reactor chamber 42.
In further variations of the present invention, the pyrolytic reactor of any of the first three embodiments may be integrated with a bin arrangement of the fourth or fifth embodiment. In such configurations, there is no need for the removable cartridge 26 as the particulate material may be arranged to be conveyed internally from the grinder 412, 502 to the first feeder unit 32.
Other systems may be employed to cool the lip of the first feeder unit 32 to those described above.
In a variation of the second embodiment, the power generated by the fuel cell 202 may be used to power devices directly connected to the housing 12.
In variations of any of the pyrolytic reactors 10,200,300 the reactor may operate multiple combinations of the first and second reactor chambers 34, 42 that feed to a centralised centrifugal separator 20. Alternatively, multiple first reactor chambers 34 may feed to a single, centralised second reactor chamber 42.
In variations of the present invention, the bins 402 may incorporate multiple grinders 412, 502. In yet further variations, either the crusher unit 430 and/or the shredder unit 428, 508 may incorporate multiple roller systems to facilitate crushing and/or shredding, as appropriate.
The bin 402 may incorporate an automatic identification or advisory system for the waste material sought to be placed therein. These systems may work in combination with the chute hatch 14 so as to prevent material that cannot be processed by the pyrolytic system 400, 500 using the present invention from being processed by the bins 402.
The grinder 412, 502 may be manually operated. Similarly, other grinders 412, 502 configurations may be used to those described.
While the embodiments of the invention have been described in which the first reactor chamber 34 is heated to between 450° C. and 600° C. this is a preferred temperature range for the currently known plastics for which the invention is suitable. However, the applicant believes that the invention may be suitable for use with other plastics where the first reactor chamber 34 is heated to between 400° C. and 650° C.
Similarly, while the embodiments of the invention have been described which the second reactor chamber 42 is heated to between 700° C. and 800° C. this is a preferred temperature range. The applicant again believes that the invention may be suitable for use with other plastics where the second reactor chamber 42 is heated to between 600° C. and 900° C.
The second and third embodiments of the invention may be modified so as to incorporate or omit the recirculatory system of the first embodiment as desired. In this manner, when included, the post-reactor gases may be processed by the fuel cell 202 or hydrogen recovery system 302 (as appropriate) multiple times in an effort to extract maximum carbon and/or hydrogen therefrom.

It should be further appreciated by the person skilled in the art that the invention is not limited to the embodiments described above. Additions or modifications described, where not mutually exclusive, can be combined to form yet further embodiments that are considered to be within the scope of the present invention.

We claim:

1. A pyrolytic reactor for recovering carbon from certain plastics comprising:
at least one reactor vessel, the at least one reactor vessel having a first reaction chamber and a second reaction chamber,
a material delivery system for delivering the certain plastics in particulate form to the first reaction chamber;
a catalyst delivery system for delivering a metal catalyst to the second reaction chamber; and
a separator,
where the particulate plastic material is heated in the first reaction chamber to a first temperature range so as to decompose into a collection of gases that are heated in the second reaction chamber in conjunction with the metal catalyst to form a collection of post-reactor gases having carbon coated catalytic material entrained therein, the separator operable to separate at least some of the carbon coated catalytic material from the post-reactor gases.

2. A pyrolytic reactor according to claim 1, where the first temperature range is between 400° C. and 650° C.

3. A pyrolytic reactor according to claim 2, where the first temperature range is between 450° C. and 600° C.

4. A pyrolytic reactor according to any one of claims 1 to 3, where the second temperature range is between 600° C. and 900° C.

5. A pyrolytic reactor according to claim 4, where the second temperature range in between 700° C. and 800° C.

6. A pyrolytic reactor according to any preceding claim, where the separator is a cyclonic separator.

7. A pyrolytic reactor according to any preceding claim where the metal catalyst is an iron-based catalyst.

8. A pyrolytic reactor according to any preceding claim, where each reaction chamber of the first reactor vessel is heated by an electric furnace.

9. A pyrolytic reactor according to claim 8, where the electric furnace is a multi-zone electric furnace, at least one zone of the multi-zone electric furnace operable to heat the first reaction chamber and at least one zone of the multi-zone electric furnace operable to heat the second reaction chamber.

10. A pyrolytic reactor according to any preceding claim, where the second reaction chamber is positioned above the first reaction chamber and a connecting chamber connects the first reaction chamber to the second reaction chamber.

11. A pyrolytic reactor according to any preceding claim, further including a perforated base plate located within the second reaction chamber, the perforations of the base plate being sized so as to allow gases to pass therethrough but prevent the metal catalyst from falling therethrough.

12. A pyrolytic reactor according to any preceding claim, further comprising a channel mixer, the channel mixer operable to deliver at least one of the following: post-reactor gases to the first reactor chamber; post-reactor gases to the second reactor chamber; nitrogen to the second reactor chamber; hydrogen to the second reactor chamber; nitrogen to the first reactor chamber; hydrogen to the first reactor chamber.

13. A pyrolytic reactor according to any preceding claim, where the material delivery system operates to unseal an opening in a sealed removable cartridge to allow the particulate plastic material contained therein to pass to a first feeder unit that delivers the particulate plastic material to the first reaction chamber.

14. A pyrolytic reactor according to claim 13, where the first feeder unit is an Archimedes screw that delivers the particulate plastic material to the bottom of the first reaction chamber.

15. A pyrolytic reactor according to any preceding claim, where the material delivery system has a feed rate of between 0.5 and 10 grams per minute.

16. A pyrolytic reactor according to claim any preceding claim, where the catalyst delivery system comprises a catalyst hopper that feeds the metal catalyst to a second feeder unit that delivers the metal catalyst to the second reaction chamber.

17. A pyrolytic reactor according to claim 16, where the second feeder unit is an Archimedes screw that delivers the metal catalyst to the top of the second reaction chamber.

18. A pyrolytic reactor according to any preceding claim, where the catalyst delivery system has a feed rate of between 0.5 and 10 grams per minute.

19. A pyrolytic reactor according to any preceding claim, where the ratio of catalyst to particulate material is one of the following: 1:2; 1:4; 1:6.

20. A pyrolytic reactor according to any preceding claim, where the post-reactor gases separated by the separator are oxidised in a combustion chamber.

21. A pyrolytic reactor according to claim 20, where the combustion chamber delivers at least some by-products of the oxidisation process back to the first reaction chamber.

22. A pyrolytic reactor according to claim 21, where the by-products are CO₂ and N₂.

23. A pyrolytic reactor according to claim 21 or claim 22, further comprising a control system, the control system operable to initiate the oxidisation process only on determination of a variable exceeding a predetermined threshold level.

24. A pyrolytic reactor according to claim 23, where the variable is one of the following: the pressure level within the combustion chamber; the number of times the post-reactor gases have passed through the combustion chamber; expiry of time.

25. A pyrolytic reactor according to any preceding claim, further including an energy recovery system to recover at least some of the chemical energy generated in the combustion chamber.

26. A pyrolytic reactor according to claim 25, where the energy recovery system is operable to provide power to an electric furnace used to heat either the first reaction chamber, the second reaction chamber, or both the first and second reaction chambers.

27. A pyrolytic reactor according to any one of claims 1 to 19, where the post-reactor gases separated by the separator are delivered to a solid-oxide fuel cell.

28. A pyrolytic reactor according to any one of claims 1 to 19, where the post-reactor gases separated by the separator are delivered to a hydrogen recovery system.

29. A pyrolytic reactor according to claim 28, where the hydrogen recovery system comprises a removable cartridge filled with metal compounds through which the post-reactor gases are directed, the metal compounds capable of absorbing hydrogen to form hydrides.

30. A device for creating particulate material from certain plastics comprising:
a receptacle into which a plastic article may be deposited;
a grinder for grinding the deposited plastic article into particulate material; and
a removable cartridge for receiving the particulate material from the grinder,
where, the removable cartridge, when removed from the device, is sealed so as to prevent the particulate material from entering the environment as it is transferred from the device to form part of the material delivery system of a pyrolytic reactor according to claim 1.

31. A device for creating particulate material from certain plastics according to claim 30, where the removable cartridge has an open face, the device operable to seal the removable cartridge by applying a protective membrane over the open face prior to removal.

32. A device for creating particulate material from certain plastics according to claim 30 or claim 31, where the receptacle incorporates an automatic identification system, the receptacle operable to allow the deposit of a plastic article on recognition of the article as recoverable by the automatic identification system.

33. A system for recovering carbon from certain plastics, the system comprising:
a pyrolytic reactor according to any one of claims 1 to 12;
a device for creating particulate material according to any one of claims 30 to 32,
where the material delivery system operates to unseal an opening in the sealed removable cartridge retrieved from the device to allow the particulate plastic material contained therein to pass to a first feeder unit that delivers the particulate plastic material to the first reaction chamber.

34. A method for recovering carbon from certain plastics, the method comprising the steps of:
heating particulate material in a first reaction chamber of at least one reactor vessel to a first temperature range so as to decompose the particulate material into a collection of gases;
delivering a metal catalyst to a second reaction chamber of at least one reactor vessel;
heating the collection of gases and the metal catalyst in the second reaction chamber to a second temperature range to form a collection of post-reactor gases having a carbon coated catalytic material entrained therein;
separating the carbon coated catalytic material from the post-reactor gases.

35. A method for recovering carbon according to claim 34, where the first temperature range is between 400° C. and 650° C.

36. A method for recovering carbon according to claim 35, where the first temperature range is between 450° C. and 560° C.

37. A method for recovering carbon according to any one of claim 34 to claim 36, where the second temperature range is between 600° C. and 900° C.

38. A method for recovering carbon according to claim 37, where the second temperature range is between 700° C. and 800° C.

39. A method for recovering carbon according to any one of claims 34 to 38 where the method of separating the carbon coated catalytic material from the post-reactor gases is achieved by centrifugal separation.

40. A method for recovering carbon according to any one of claims 34 to 39, where the catalyst is an iron-based catalyst.

41. A method for recovering carbon according to any one of claims 34 to 40, further comprising the step of using the collection of gases to agitate the catalyst in the second reaction chamber.

42. A method for recovering carbon according to any one of claims 34 to 41, further comprising the step of using a channel mixer to deliver at least one of the following: post-reactor gases to the first reactor chamber; post-reactor gases to the second reactor chamber; nitrogen to the second reactor chamber; hydrogen to the second reactor chamber; nitrogen to the first reactor chamber; hydrogen to the second reactor chamber.

43. A method for recovering carbon according to any one of claims 34 to 42, further comprising the steps of:
unsealing an opening in a sealed removable cartridge to allow the particulate plastic material contained therein to pass to a first feeder unit; and
using the first feeder unit to deliver the particulate plastic material to the first reaction chamber.

44. A method for recovering carbon according to claim 43, where the first feeder unit delivers particulate material to the first reaction chamber at a feed rate of between 0.5 and 10 grams per minute.

45. A method for recovering carbon according to any one of claims 34 to 44, further comprising the step of feeding the metal catalyst to the top of the second reaction chamber at a feed rate of between 0.5 and 10 grams per minute.

46. A method for recovering carbon according to any one of claims 34 to 45, where the ratio of the feed rate of the catalyst to the feed rate of the particulate material is one of the following: 1:2; 1:4; 1:6.

47. A method for recovering carbon according to any one of claims 34 to 46, further comprising the step of oxidising the post-reactor gases in a combustion chamber.

48. A method for recovering carbon according to claim 47, further comprising the step of delivering at least some by-products of the oxidisation process back to the first reaction chamber.

49. A method for recovering carbon according to claim 48, where the by-products are CO₂ and N₂.

50. A method for recovering carbon according to any one of claims 47 to 49, where the step of oxidising the post-reactor gases in the combustion chamber is only initiated when a control system determines that a variable exceeds a predetermined threshold level.

51. A method for recovering carbon according to claim 50, where the variable is one of the following: the pressure level within the combustion chamber; the number of times the post-reactor gases have passed through the combustion chamber; expiry of time.

52. A method of recovering carbon according to any one of claims 34 to 51, further comprising the steps of:
recovering at least some chemical energy generated in the combustion chamber; and
using the recovered energy to power an electric furnace used to heat either the first reaction chamber, the second reaction chamber, or both the first and second reaction chambers.

53. A method of recovering carbon according to any one of claims 34 to 46, further comprising the step of delivering the post-reactor gases to a solid-oxide fuel cell.

54. A method of recovering carbon according to any one of claims 34 to 46, further comprising the step of delivering the post-reactor gases to a hydrogen recovery system.

55. A method of recovering carbon according to claim 54, where the hydrogen recovery system comprises a removable cartridge filled with metal compounds through which the post-reactor gases are directed, the metal compounds capable of absorbing hydrogen to form hydrides.

56. A method of recovering carbon according to any one of claims 34 to 55, further comprising the steps of:
grinding a deposited plastic article into particulate material;
depositing the particulate material into a removable cartridge; and
sealing the removable cartridge so as to prevent the particulate material from entering the environment during transfer.

57. A method of recovering carbon according to claim 56, further comprising the steps of:
identifying a plastic article; and
allowing the plastic article to be deposited for grinding only if the plastic article is recognised as being made from, or predominantly from, one of the certain plastics.
